(19) United States
(12) Patent Application Publication
(10) Pub. No.: US 2018/0359398 A1
(43) Pub. Date: Dec. 13, 2018

(54) IMAGE PROCESSING DEVICE

(71) Applicant: AISIN SEIKI KABUSHIKI KAISHA, Kariya-shi (JP)

(72) Inventors: Haruyuki HORIE, Okazaki-shi (JP); Miki TSUJINO, Wako-shi (JP)

(73) Assignee: AISIN SEIKI KABUSHIKI KAISHA, Kariya-shi (JP)

(21) Appl. No.: 15/988,466

(22) Filed: May 24, 2018

(30) Foreign Application Priority Data
Jun. 9, 2017 (JP) 2017-114665

(51) Int. Cl. H04N 5/235; G06T 7/90; G06T 7/11; G06T 5/50; H04N 5/247

(52) U.S. Cl. CPC H04N 5/235; G06T 7/90; G06T 7/11; G06T 2207/20224; H04N 5/247; G06T 2207/10024; G06T 2207/20216; G06T 5/50

(57) ABSTRACT

According to one embodiment, an image processing device includes imagers disposed on an outer circumference of a mobile object, for capturing surroundings of the mobile object to generate multiple images including mutually overlapping regions, a processor that corrects luminance of the images through a first correction, and corrects color differences in the images through a second correction different from the first correction, to generate a peripheral image by combining the corrected images. In the first correction, the processor corrects, based on a value regarding a luminance of a target region set in an overlapping region of a first one of the images, luminance of a target region in a second one of the images. In the second correction, the processor corrects color difference in the first or second one of the images based on a value regarding color-difference between the first one and the second one of the images.

### CROSS-REFERENCE TO RELATED APPLICATIONS

This application is based upon and claims the benefit of priority from Japanese Patent Application No. 2017-114665, filed Jun. 9, 2017, the entire contents of which are incorporated herein by reference.

### FIELD

Embodiments described herein relate generally to an image processing device.

### BACKGROUND

Devices that include multiple imaging units mounted on a mobile object to generate a peripheral image by combining images generated by the imaging units are known. Such a device corrects the generated images to improve the image quality of the peripheral image. For example, to generate peripheral images, the device corrects the images such that the mean values of the respective color components (such as YUV) among the images become equal to each other (disclosed in Japanese Laid-open Patent Application Publication No. 2011-181019 and No. 2002-324235, for example).

However, such a device cannot sufficiently improve the image quality of peripheral images because of the image correction that the mean values of the color components become equalized among the images.

An object of the present invention is to provide an image processing device which can improve the image quality of peripheral images generated from combined images.

### SUMMARY

An image processing device comprising: a plurality of imagers disposed on an outer circumference of a mobile object, the imagers imaging surroundings of the mobile object to generate multiple images including mutually overlapping regions; a processor that corrects luminance of the images through a first correction, and corrects color differences in the images through a second correction different from the first correction, to generate a peripheral image by combining the corrected images, wherein in the first correction, the processor corrects, on the basis of a value regarding a luminance of a target region set in an overlapping region of a first one of the images, luminance of a target region set in a second one of the images; and in the second correction, the processor corrects color difference in the first or second one of the images on the basis of a value regarding color-difference between the first one and the second one of the images.

Thus, the image processing device corrects the luminance of the target region in accordance with the luminance of one of the images, and corrects the color differences among the images in accordance with the color difference between two or more of the images, that is, the luminance correction and the color-difference correction are differentiated. Thereby, the image processing device can abate phenomenon such as blown out highlights and blocked up shadows in the images, which would occur when the luminance and the color differences are corrected in the same manner. Consequently, the image processing device can properly correct variations in the color differences among the images due to the characteristics and the mount positions of the imagers and improve the image quality of the peripheral images generated from the images by combining them.

In the image processing device of the present invention, in the second correction, the processor may correct the color difference in the image on the basis of an overall color-difference mean value and a single-image color-difference mean value, the overall color-difference mean value being an average of color differences among all of target regions or all the images, the single-image color-difference mean value being an average of color differences in the target region of the first one of the images.

Thus, the image processing device corrects the color differences among the images on the basis of the single-image color-difference mean value of each image and the overall color-difference mean value, thereby avoiding an increase in the calculation load of the correction process and enabling reduction in unnaturalness of the color differences among the images.

In the image processing device of the present invention, the processor may determine, on the basis of the color-difference mean value of the target regions and a preset color-difference mean threshold, whether to perform the second correction.

Thus, the image processing device determines whether to perform the correction on the basis of the color-difference mean value and the color-difference mean threshold, therefore, can forbid setting erroneous correction values when the images contain no road surface. Thereby, the image processing device can prevent the peripheral image from degrading in image quality by an erroneous correction value.

In the image processing device of the present invention, the processor may determine, on the basis of a variation in the color differences in the target regions and a preset variation threshold, whether to perform the second correction.

Thus, the image processing device determines whether to perform the correction on the basis of a variation in the color differences and the variation threshold, therefore, can forbid setting the color-difference correction value when the images contain a white line. Thereby, the image processing device can prevent false color arising from the correction value and prevent the degradation of the image quality of the peripheral image.

In the image processing device of the present invention, the processor may determine, on the basis of a difference in color-difference mean values of target regions of the first one of the images and a preset difference threshold, whether to perform the second correction.

Thus, the image processing device determines whether to perform the correction on the basis of the difference in the color-difference mean values of one of the images and the difference threshold, therefore, can forbid setting an erroneous color-difference correction value when the one image exhibits uneven color differences with a great variation. Thereby, the image processing device can prevent the degradation of the image quality of the peripheral image due to an erroneous color-difference correction value.

In the image processing device of the present invention, the processor may determine, on the basis of a correction value for correcting the color difference and a preset upper-limit correction value, whether to change the correction value to the upper-limit correction value.

Thus, the image processing device can prevent the degradation of the image quality of the peripheral image due to a great color change caused by a large correction value, by using the set correction value and the upper-limit correction value.

In the image processing device of the present invention, the processor may change the correction value to the upper-limit correction value when the correction value set for correcting color-difference exceeds the upper-limit correction value.

Thus, the image processing device can set the correction value to a proper value (i.e., the upper-limit correction value) when the correction value is too large.

### BRIEF DESCRIPTION OF THE DRAWINGS

FIG. 1 is a plan view of a vehicle on which an image processing device according to a first embodiment is mounted;

FIG. 2 is a block diagram of the structure of the image processing device mounted on the vehicle;

FIG. 3 is a functional block diagram of an information processing unit;

FIG. 4 is a view for illustrating image correction by a corrector;

FIG. 5 is a flowchart of image generation process executed by a processor of the first embodiment;

FIG. 6 is a flowchart of luminance correction process executed by the corrector;

FIG. 7 is a flowchart of color-difference correction process executed by the corrector;

FIG. 8 is a flowchart of color-difference correction process executed by a corrector of a second embodiment;

FIG. 9 is a flowchart of color-difference mean value determination process executed by the corrector;

FIG. 10 is a flowchart of color-difference variation determination process executed by the corrector;

FIG. 11 is a flowchart of color-difference difference determination process executed by the corrector; and

FIG. 12 is a flowchart of upper-limit correction value determination process executed by the corrector.

### DETAILED DESCRIPTION

Hereinafter, exemplary embodiments will be described. Throughout the embodiments, same or like elements are denoted by common reference numerals and their overlapping descriptions will be omitted when appropriate.

### First Embodiment

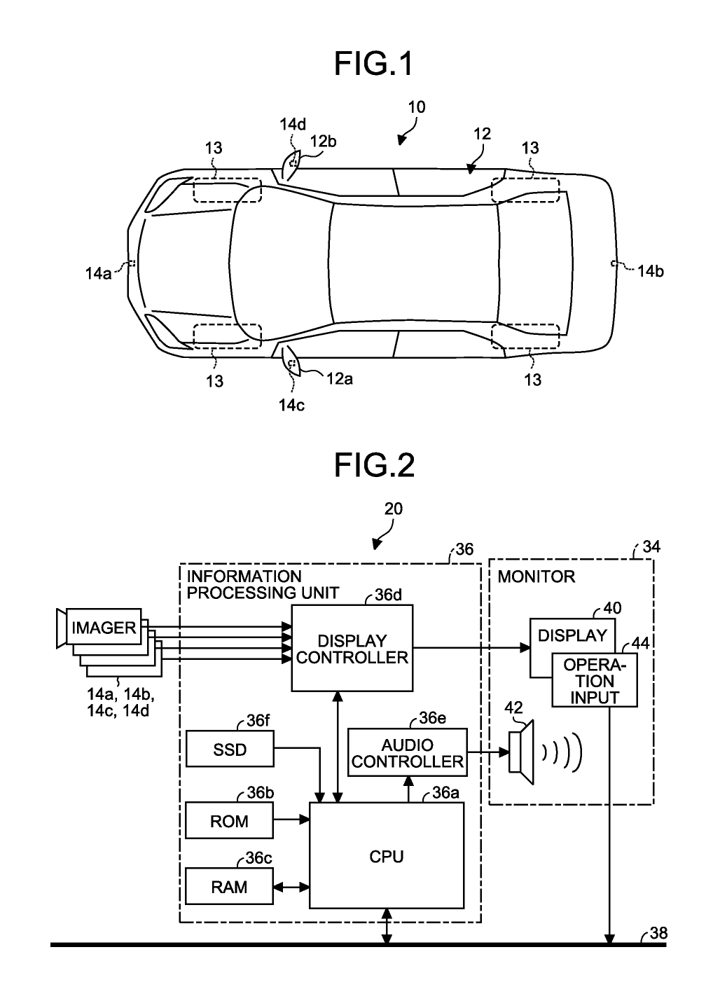

FIG. 1 is a plan view of a vehicle 10 on which an image processing device according to a first embodiment is mounted. The vehicle 10 is an exemplary mobile object, and may be an automobile (internal-combustion automobile) including an internal combustion (engine, not illustrated) as a power source, an automobile (electric automobile or fuel-cell automobile) including an electric motor (not illustrated) as a power source, or an automobile (hybrid automobile) including both of them as a power source. The vehicle 1 can incorporate a variety of transmissions and a variety of devices (systems, parts or components) necessary for driving the internal combustion or the electric motor. Types, numbers, and layout of devices involving in driving wheels 13 of the vehicle 10 can be variously set.

As illustrated in FIG. 1, the vehicle 10 includes a vehicle body 12 and multiple (four, for instance) imagers 14a, 14b, 14c, 14d. The imagers 14a, 14b, 14c, 14d will be collectively referred to as imagers 14, unless they need to be individually distinguished.

The vehicle body 12 defines a vehicle interior in which an occupant rides. The vehicle body 12 contains or holds the elements of the vehicle 10, such as the wheels 13 and the imagers 14.

The imagers 14 are, for example, digital cameras incorporating image sensors such as charge coupled devices (CCD) or CMOS image sensors (CIS). The imagers 14 output, as image data, video data containing frame images generated at a certain frame rate, or still image data. The imagers 14 each include a wide-angle lens or a fisheye lens to be able to capture the horizontal angular range of 140 to 190 degrees. The optical axes of the imagers 14 are oriented diagonally downward. The imagers 14 thus image the surroundings of the vehicle 10 including surrounding road surfaces and output image data.

The imagers 14 are disposed on the outer circumference of the vehicle 10. For example, the imager 14a is disposed at about the lateral center of the front (such as a front bumper) of the vehicle 10. The imager 14a generates an image of an area ahead of the vehicle 10. The imager 14b is disposed at about the lateral center of the rear (such as a rear bumper) of the vehicle 10. The imager 14b generates an image of an area behind the vehicle 10. The imager 14c is disposed at about the lengthwise center of the left side (such as a left side mirror 12a) of the vehicle 10 adjacent to the imager 14a and the imager 14b. The imager 14c generates an image of an area on the left side of the vehicle 10. The imager 14d is disposed at about the lengthwise center of the right side (such as a right side mirror 12b) of the vehicle 10 adjacent to the imager 14a and the imager 14b. The imager 14d generates an image of an area on the right side of the vehicle 10. The imagers 14a, 14b, 14c, 14d generate images containing mutually overlapping regions.

FIG. 2 is a block diagram of the structure of an image processing device 20 mounted on the vehicle 10. As illustrated in FIG. 2, the image processing device 20 includes the imagers 14, a monitor 34, an information processing unit 36, and an in-vehicle network 38.

The monitor 34 is provided on a dashboard in the vehicle interior, for example. The monitor 34 includes a display 40, an audio output 42, and an operation input 44.

The display 40 displays an image on the basis of image data transmitted from the information processing unit 36. The display 40 is a device such as a liquid crystal display (LCD) and an organic electroluminescent display (OELD). The display 40 displays, for instance, a peripheral image that is generated by the information processing unit 36 by combining the images generated by the imagers 14.

The audio output 42 outputs audio based on audio data transmitted from the information processing unit 36. The audio output 42 is a speaker, for example. The audio output 42 may be disposed at a different position from the display 40 in the vehicle interior.

The operation input 44 receives inputs from the occupant. The operation input 44 is exemplified by a touch panel. The operation input 44 is provided on the screen of the display 40. The operation input 44 is transparent, allowing the image on the display 40 to be see-through. Thereby, the operation input 44 allows the occupant to view images displayed on the screen of the display 40. The operation input 44 receives an instruction from the occupant with his or her touch on the screen of the display 40 corresponding to the image displayed thereon, and transmits the instruction to the information processing unit 36.

The information processing unit 36 is a computer including a microcomputer such as an electronic control unit (ECU). The information processing unit 36 acquires image data from the imagers 14. The information processing unit 36 transmits a peripheral image based on images or audio data to the monitor 34. The information processing unit 36 includes a central processing unit (CPU) 36a, a read only memory (ROM) 36b, a random access memory (RAM) 36c, a display controller 36d, an audio controller 36e, and a solid state drive (SSD) 36f. The CPU 36a, the ROM 36b, and the RAM 36c may be integrated in the same package.

The CPU 36a is an exemplary hardware processor, and reads a program from a non-volatile storage such as the ROM 36b and performs various calculations and controls by the program. The CPU 36a corrects and combines images to generate a peripheral image to be displayed on the display 40, for example.

The ROM 36b stores programs and parameters necessary for execution of the programs. The RAM 36c temporarily stores a variety of kinds of data used in the calculations by the CPU 36a. Among the calculations in the information processing unit 36, the display controller 36d mainly implements image processing to images generated by the imagers 14 and data conversion of images for display on the display 40. The audio controller 36e mainly implements processing to audio for output from the audio output 42. The SSD 36f is a non-volatile, rewritable memory device and retains data irrespective of the power-off of the information processing unit 36.

The in-vehicle network 38 is, for example, a controller area network (CAN). The in-vehicle network 38 electrically connects the information processing unit 36 and the operation input 44, allowing them to mutually transmit receive signals and information.

According to the present embodiment, the information processing unit 36 deals with image generation process for the vehicle 10 by cooperation of hardware and software (control program). The information processing unit 36 corrects and combines images including surrounding images generated by the imagers 14 to generate a peripheral image.

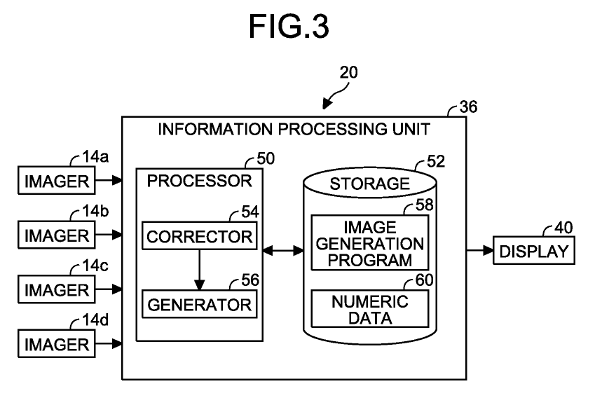

FIG. 3 is a function block diagram of the information processing unit 36. As illustrated in FIG. 3, the information processing unit 36 includes a processor 50 and a storage 52.

The processor 50 is implemented by the functions of the CPU 36a, for example. The processor 50 includes a corrector 54 and a generator 56. The processor 50 may read an image generation program 58 from the storage 52, for example, to implement the functions of the corrector 54 and the generator 56. The corrector 54 and the generator 56 may be partially or entirely made of hardware as circuitry including an application specific integrated circuit (ASIC).

The corrector 54 acquires an image containing multiple overlapping regions from each of the imagers 14. That is, the corrector 54 acquires images of at least the number equal to the number of the imagers 14. The images can be exemplified by one frame of a video. The corrector 54 corrects luminance and color difference of each pixel of each image. Luminance represents Y values in YUV space, for example. Color difference represents values obtained by subtracting a color signal from luminance, for instance, U values (values by subtracting luminance from a blue signal) and V values (values by subtracting luminance from a red signal) in YUV space. The corrector 54 sets a target region in each of the overlapping regions. The corrector 54 first corrects the luminance of the images. Specifically, in the first correction the corrector 54 corrects, on the basis of a value regarding the luminance of a target region of one (e.g., front-side or rear-side image) of the images, the luminance of a target region of another image (e.g., left-side or right-side image). In the first correction the corrector 54 may correct, for example, the luminance of an area outside the target region by linear interpolation using the luminance of the corrected target region. Secondly, the corrector 54 corrects color differences among the images. Specifically, the corrector 54 corrects, on the basis of a value regarding the color difference between target regions of two or more (e.g., all the images) of the images, the color differences among the images. The two or more of the images are an example of a first one and a second one of the images. In the second correction, for example, the corrector 54 corrects the color difference in the one image on the basis of an overall color-difference mean value, which represents an average of color-difference values of the target regions in all the images, and a single-image color-difference mean value, which represents an average of color-difference values of target regions in one image. Thus, the corrector 54 corrects the color differences among the images through the second correction different from the first correction. The corrector 54 outputs the corrected images to the generator 56.

The generator 56 acquires and combines the corrected images from the corrector 54 to generate a peripheral image. The generator 56 outputs the generated peripheral image to the display 40 for display.

The storage 52 is implemented as the function of at least one of the ROM 36b, the RAM 36c, and the SSD 36f. The storage 52 stores programs to be executed by the processor 50 and necessary data for execution of the programs. For instance, the storage 52 stores the image generation program 58 executed by the processor 50 and numeric data 60 necessary for execution of the image generation program 58.

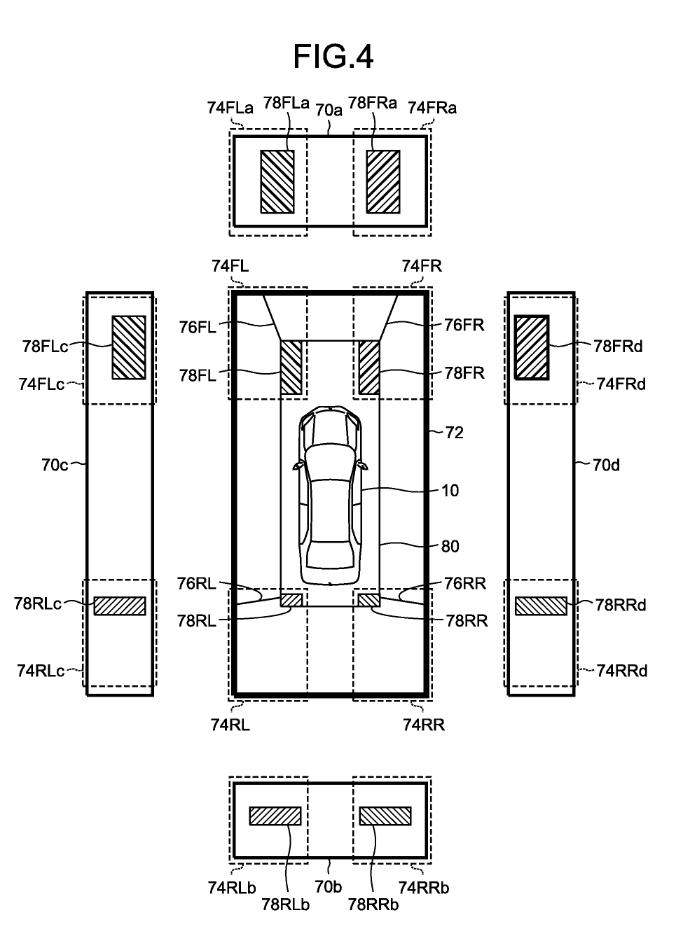

FIG. 4 is a view for illustrating the image correction by the corrector 54.

In FIG. 4 four images 70a, 70b, 70c, 70d acquired by the corrector 54 from the imagers 14a, 14b, 14c, 14d, respectively, are surrounded by bold-line rectangular frames. FIG. 4 shows a peripheral image 72 surrounded by a bold-line rectangular frame in the center. The peripheral image 72 is generated by combining the images 70a, 70b, 70c, 70d. The peripheral image 72 is an overview image or a bird's-eye view image, showing the surroundings of the vehicle 10 from above. The peripheral image 72 includes an overlapping region 74FL, an overlapping region 74FR, an overlapping region 74RL, and an overlapping region 74RR of the images 70a, 70b, 70c, 70d.

The front-side image 70a and the left-side image 70c include an overlapping region 74FLa and an overlapping region 74FLc, respectively. The overlapping region 74FLa and the overlapping region 74FLc correspond to the overlapping region 74FL. The front-side image 70a and the right-side image 70d include an overlapping region 74FRa and an overlapping region 74FRd, respectively. The overlapping region 74FRa and the overlapping region 74FRd correspond to the overlapping region 74FR. The rear-side image 70b and the left-side image 70c include an overlapping region 74RLb and an overlapping region 74RLc, respectively. The overlapping region 74RLb and the overlapping region 74RLc correspond to the overlapping region 74RL. The rear-side image 70b and the right-side image 70d includes an overlapping region 74RRb and an overlapping region 74RRd, respectively. The overlapping region 74RRb and the overlapping region 74RRd correspond to the overlapping region 74RR.

Straight border lines 76FL, 76FR, 76RL, 76RR are illustrated in the peripheral image 72. The border lines 76FL, 76FR, 76RL, 76RR will be collectively referred to as border lines 76 unless they need to be individually distinguished. The border line 76FL is a border between the front-side image 70a and the left-side image 70c. The border line 76FR is a border between the front-side image 70a and the right-side image 70d. The border line 76RL is a border between the rear-side image 70b and the left-side image 70c. The border line 76RR is a border between the rear-side image 70b and the right-side image 70d. The angles of the border lines 76FL, 76FR, 76RL, 76RR are preset and stored as the numeric data 60 in the storage 52.

The front-side image 70a covers the area between the border line 76FL and the border line 76FR. The left-side image 70c covers the area between the border line 76FL and the border line 76RL. The right-side image 70d covers the area between the border line 76FR and the border line 76RR. The rear-side image 70b covers the area between the border line 76RL and the border line 76RR.

The corrector 54 sets target regions 78FL, 78FR, 78RL, 78RR, indicated by hatching, in the overlapping regions 74FL, 74FR, 74RL, 74RR of the peripheral image 72, respectively. The target regions 78FL, 78FR, 78RL, 78RR are also referred to as regions of interest (ROI). The target regions 78FL, 78FR, 78RL, 78RR are not limited to specific regions but may be appropriately set in the respective overlapping regions 74FL, 74FR, 74RL, 74RR by the corrector 54 in accordance with a set frame 80, the angles of the border lines 76, and the width of the vehicle 10. The set frame 80 is exemplified by a preset parking frame. The set frame 80 for setting the target regions 78FL, 78FR, 78RL, 78RR, the angles of the border lines 76, and the width of the vehicle 10 are stored as the numeric data 60 in the storage 52.

The target region 78FLa and the target region 78FRa in the front-side image 70a correspond to the target region 78FL and the target region 78FR in the peripheral image 72, respectively. The target region 78RLb and the target region 78RRb in the rear-side image 70b correspond to the target region 78RL and the target region 78RR in the peripheral image 72, respectively. The target region 78FLc and the target region 78RLc in the left-side image 70c correspond to the target region 78FL and the target region 78RL in the peripheral image 72, respectively. The target region 78FRd and the target region 78RRd in the right-side image 70d correspond to the target region 78FR and the target region 78RR in the peripheral image 72, respectively.

The images 70a to 70d will be collectively referred to as images 70 unless they need to be individually distinguished. The overlapping regions 74FL . . . will be collectively referred to as overlapping regions 74 unless they need to be individually distinguished. The target regions 78FL . . . will be collectively referred to as target regions 78 unless they need to be individually distinguished.

The luminance correction process by the corrector 54 is now described.

The corrector 54 calculates a mean value of the luminance (Y values) of all the pixels in the target region 78FLa of the front-side image 70a (hereinafter, reference left-anterior mean luminance value). The corrector 54 calculates a mean value of the luminance of all the pixels in the target region 78FRa of the front-side image 70a (hereinafter, reference right-anterior mean luminance value). The corrector 54 calculates a mean value of the luminance of all the pixels in the target region 78RLb of the rear-side image 70b (hereinafter, reference left-posterior mean luminance value). The corrector 54 calculates a mean value of the luminance of all the pixels in the target region 78RRb of the rear-side image 70b (hereinafter, reference right-posterior mean luminance value).

The corrector 54 calculates a mean value of the luminance of all the pixels in the target region 78FLc of the left-side image 70c (hereinafter, left-anterior mean luminance value). The corrector 54 calculates a difference between the reference left-anterior mean luminance value of the target region 78FLa and the left-anterior mean luminance value of the target region 78FLc (hereinafter, left-anterior luminance difference). The corrector 54 corrects the luminance of the target region 78FLc of the left-side image 70c by adding or subtracting the left-anterior luminance difference to or from the luminance of all the pixels in the target region 78FLc, so that the left-anterior mean luminance value becomes equal to the reference left-anterior mean luminance value.

The corrector 54 calculates a mean value of the luminance of all the pixels in the target region 78RLc of the left-side image 70c (hereinafter, left-posterior mean luminance value). The corrector 54 calculates a difference between the reference left-posterior mean luminance value of the target region 78RLb and the left-posterior mean luminance value of the target region 78RLc (hereinafter, left-posterior luminance difference). The corrector 54 corrects the luminance of the target region 78RLc of the left-side image 70c by adding or subtracting the left-posterior luminance difference to or from the luminance of all the pixels in the target region 78RLc, so that the left-posterior mean luminance value becomes equal to the reference left-posterior mean luminance value.

The corrector 54 corrects the luminance of the area outside the target region 78FLc and the target region 78RLc in the left-side image 70c by linear interpolation using the left-anterior mean luminance value of the target region 78FLc and the left-posterior mean luminance value of the target region 78RLc after the correction.

The corrector 54 calculates a mean value of the luminance of all the pixels in the target region 78FRd of the right-side image 70d (hereinafter, right-anterior mean luminance value). The corrector 54 calculates a difference between the reference right-anterior mean luminance value of the target region 78FRa and the right-anterior mean luminance value of the target region 78FRd (hereinafter, right-anterior luminance difference). The corrector 54 corrects the luminance of the target region 78FRd of the right-side image 70d by adding or subtracting the right-anterior luminance difference to or from the luminance of all the pixels in the target region 78FRd, so that the right-anterior mean luminance value becomes equal to the reference right-anterior mean luminance value.

The corrector 54 calculates a mean value of the luminance of all the pixels in the target region 78RRd of the right-side image 70d (hereinafter, right-posterior mean luminance value). The corrector 54 calculates a difference between the reference right-posterior mean luminance value of the target region 78RRb and the right-posterior mean luminance value of the target region 78RRd (hereinafter, right-posterior luminance difference). The corrector 54 corrects the luminance of the target region 78RRd of the right-side image 70d by adding or subtracting the right-posterior luminance difference to or from the luminance of all the pixels in the target region 78RRd, so that the right-posterior mean luminance value becomes equal to the reference right-posterior mean luminance value.

The corrector 54 corrects the luminance of the area outside the target region 78FRd and the target region 78RRd in the right-side image 70d by linear interpolation using the right-anterior mean luminance value of the target region 78FRd and the right-posterior mean luminance value of the target region 78RRd after the correction.

Next, the color-difference correction process by the corrector 54 is described.

The corrector 54 corrects each of the color differences among the images 70 on the basis of the overall color-difference mean value, which represents an average of the color differences among all the target regions 78 in the overlapping regions 74 of all the images 70, and the single-image color-difference mean value, which represents an average of the color differences among all the target regions 78 in all the overlapping regions 74 of the one image 70.

First, the correction of U values of the color differences is described in detail.

The corrector 54 calculates a single-image color-difference mean value being an average of color differences (U values in the present embodiment) in each of the images 70 (i.e., for each of the imagers 14).

Specifically, the corrector 54 calculates a U mean value of the front-side image being an average of U values of the front-side image 70a by the imager 14a by dividing the total sum of U values of both of the target regions 78FLa and 78FRa by the number of pixels in the target regions 78FLa and 78FRa.

Likewise, the corrector 54 calculates a U mean value of the rear-side image being an average of U values of the rear-side image 70b by the imager 14b by dividing the total sum of U values of both of the target regions 78RLb and 78RRb by the number of pixels in the target regions 78RLb and 78RRb.

The corrector 54 calculates a U mean value of the left-side image being an average of U values of the left-side image 70c by the imager 14c by dividing the total sum of U values of both of the target regions 78FLc and 78RLc by the number of pixels in the target regions 78FLc and 78RLc.

The corrector 54 calculates a U mean value of the right-side image being an average of U values of the right-side image 70d by the imager 14d by dividing the total sum of U values of both of the target regions 78FRd and 78RRd by the number of pixels in the target regions 78FRd and 78RRd.

The U mean values of the front-side image, the rear-side image, the left-side image, and the right-side image are examples of the single-image color-difference mean value, and may be collectively referred to as a single-image U mean value unless they need to be individually distinguished. The color-difference mean value regarding V values will be referred to as a single-image V mean value. The single-image U mean value and V mean value will be collectively referred to as a single-image color-difference mean value unless they need to be individually distinguished.

The corrector 54 calculates the sum of the U values of all the target regions 78 of all the images 70. The corrector 54 divides the sum of the U values by the numbers of pixels in all the target regions 78 to calculate an overall U mean value. The overall U mean value is an exemplary overall color-difference mean value.

The corrector 54 corrects the U values of all the pixels in each of the images 70 so that each single-image U mean value matches the overall U mean value.

For example, the corrector 54 calculates a difference between the U mean value of the front-side image and the overall U mean value as a correction value for the imager 14a. The corrector 54 corrects the U mean value of the front-side image to the overall U mean value by adding or subtracting the correction value to or from the U values of all the pixels in the front-side image 70a.

The corrector 54 calculates a difference between the U mean value of the rear-side image and the overall U mean value as a correction value for the imager 14b. The corrector 54 corrects the U mean value of the rear-side image to the overall U mean value by adding or subtracting the correction value to or from the U values of all the pixels in the rear-side image 70b.

The corrector 54 calculates a difference between the U mean value of the left-side image and the overall U mean value as a correction value for the imager 14c. The corrector 54 corrects the U mean value of the left-side image to the overall U mean value by adding or subtracting the correction value to or from the U values of all the pixels in the left-side image 70c.

The corrector 54 calculates a difference between the U mean value of the right-side image and the overall U mean value as a correction value for the imager 14d. The corrector 54 corrects the U mean value of the right-side image to the overall U mean value by adding or subtracting the correction value to or from the U values of all the pixels in the right-side image 70d.

The corrector 54 corrects V values in the same manner.

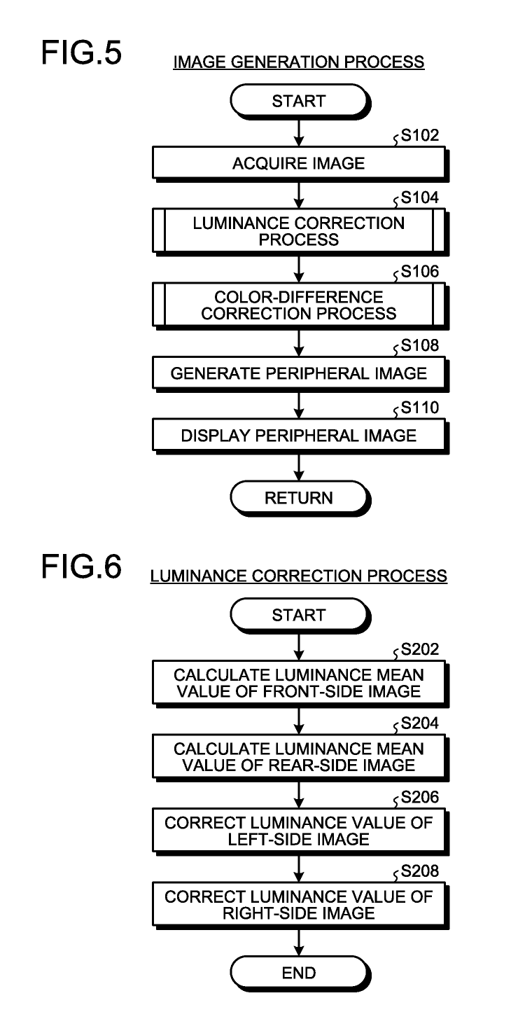

FIG. 5 is a flowchart of the image generation process executed by the processor 50 of the first embodiment. The processor 50 reads the image generation program 58 to execute the image generation process.

As illustrated in FIG. 5, the corrector 54 of the processor 50 acquires the image 70 containing the mutually overlapping regions 74 from each of the imagers 14 (S102). That is, the corrector 54 acquires the same number of images 70 as that of the imagers 14.

The corrector 54 executes luminance correction (the first correction) to the images 70 (S104).

The corrector 54 then executes color-difference (including U value and V value) correction (the second correction) to the images 70 (S106).

The generator 56 combines the corrected images 70 by the corrector 54 to generate the peripheral image 72 (S108).

The generator 56 outputs the peripheral image 72 to the display 40 for display (S110). The processor 50 repeats the step S102 and the following steps to repeatedly generate the peripheral images 72.

FIG. 6 is a flowchart of the luminance correction process executed by the corrector 54.

In the luminance correction process of FIG. 6, the corrector 54 calculates the reference left-anterior mean luminance value and the reference right-anterior mean luminance value as an average of luminance values of the target regions 78FLa, 78FRa of the front-side image 70a, respectively (S202). The corrector 54 calculates the reference left-posterior mean luminance value and the reference right-posterior mean luminance value as an average of luminance values of the target regions 78RLb, 78RRb of the rear-side image 70b, respectively (S204).

The corrector 54 corrects the luminance of the left-side image 70c (S206). Specifically, the corrector 54 corrects the luminance of the target region 78FLc of the left-side image 70c on the basis of the difference between the left-anterior mean luminance value being the mean luminance value of the target region 78FLc and the reference left-anterior mean luminance value. The corrector 54 corrects the luminance of the target region 78RLc of the left-side image 70c on the basis of the difference between the left-posterior mean luminance value being the mean luminance value of the target region 78RLc and the reference left-posterior mean luminance value. The corrector 54 corrects the luminance of the area of the left-side image 70c outside the target regions 78FLc, 78RLc by linear interpolation using the left-anterior mean luminance value and the left-posterior mean luminance value after the correction.

The corrector 54 corrects the luminance of the right-side image 70d (S208). Specifically, the corrector 54 corrects the luminance of the target region 78FRd of the right-side image 70d on the basis of the difference between the right-anterior mean luminance value being the mean luminance value of the target region 78FRd and the reference right-anterior mean luminance value. The corrector 54 corrects the luminance of the target region 78RRd of the right-side image 70d on the basis of the difference between the right-posterior mean luminance value being the mean luminance value of the target region 78RRd and the reference right-posterior mean luminance value. The corrector 54 corrects the luminance of the area outside the target regions 78FRd, 78RRd in the right-side image 70d by linear interpolation using the right-anterior mean luminance value and the right-posterior mean luminance value after the correction.

Thereby, the corrector 54 completes the luminance correction process and returns to the image generation process.

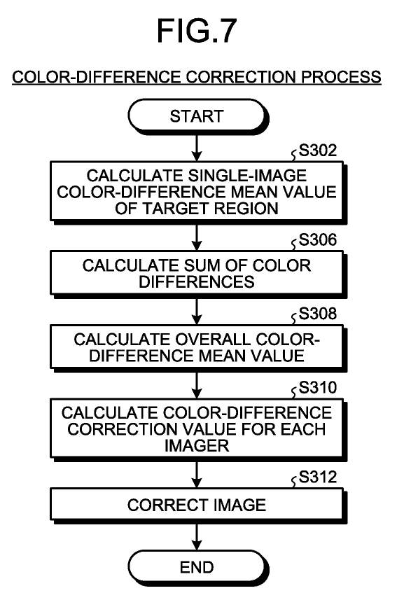

FIG. 7 is a flowchart of the color-difference correction process executed by the corrector 54.

As illustrated in FIG. 7, the corrector 54 calculates the single-image color-difference mean value being the average of color-difference values of the target region 78 for each of the images 70 (or each of the imagers 14) and for each color difference (S302). Specifically, the corrector 54 divides the total sum of the U values of all the target regions 78 (e.g., target regions 78FLa, 78FRa) of any of the images 70 (e.g., image 70a) by the number of the pixels in all the target regions 78 to calculate the single-image U mean value (e.g., U mean value of the front-side image) as the single-image color-difference mean value of the U values of the image 70 (e.g., image 70a). Likewise, the corrector 54 calculates the single-image V mean value of the image 70 (e.g., V mean value of the front-side image). Through repetition of the above process, the corrector 54 calculates the single-image U mean values and V mean values of the images 70 by all the imagers 14.

Upon completion of calculating the single-image U mean values and V mean values of all the images 70, the corrector 54 calculates the sum of the color-difference values (each of the sums of U values and V values) being the total sum of color differences in all the target regions 78 of all the images 70 (S306). The corrector 54 calculates, for each color difference, the overall color-difference mean value (i.e., overall U mean value and overall V mean value) by dividing the sum of the color-difference values by the number of pixels in all the target regions 78 (S308).

The corrector 54 calculates a correction value for each color difference for each of the imagers 14 (S310). Specifically, the corrector 54 sets the difference between the single-image U mean value of the front-side image 70a of the imager 14a and the overall U mean value as the U value correction value for the imager 14a. The corrector 54 repeats the same process for the imagers 14b, 14c, 14d to calculate the U value correction values for all the imagers 14. The corrector 54 sets the difference between the single-image V mean value of the front-side image 70a of the imager 14a and the overall V mean value as the V value correction value for the imager 14a. The corrector 54 repeats the same process for the imagers 14b, 14c, 14d to calculate the V value correction values for all the imagers 14. The corrector 54 stores the calculated correction values in the storage 52 in association with the color differences and the imagers 14.

The corrector 54 corrects the images 70 by adding or subtracting, to or from the color differences among the pixels in the images 70, the correction values associated with the imagers 14 having generated the images 70 (S312). For instance, the corrector 54 adds the U value correction value to the U values of the imager 14 exhibiting a lower single-image U mean value than the overall U mean value. The corrector 54 subtracts the U value correction value from the U values of the imager 14 exhibiting a higher single-image U mean value than the overall U mean value.

Thereby, the corrector 54 completes the color-difference correction process and returns to the image generation process.

As described above, the image processing device 20 of the first embodiment corrects the luminance of the target regions 78 of the rest of the images 70 according to the luminance of the target region 78 of one of the images 70, and corrects the color differences among the images 70 according to the color differences between two or more of the images 70. Thus, the luminance correction and the color-difference correction to the images 70 are differentiated. Thereby, the image processing device 20 can abate the phenomenon as blown out highlights and blocked up shadows in any of the images 70, which would occur when the luminance and the color difference are corrected in the same manner. Consequently, the image processing device 20 can properly correct variations in the color differences among the images 70 due to the characteristics and the mount positions of the imagers 14, and can improve the image quality of the peripheral images 72 generated from the images 70 by combining them.

Further, the image processing device 20 corrects the color differences among the images 70 on the basis of the single-image color-difference mean value of each image 70 and the overall color-difference mean value, thereby avoiding increase in the calculation load of the correction process and enabling reduction in unnaturalness of the color differences among the images 70.

### Second Embodiment

Next, a second embodiment including a modification of the above color-difference correction process is described. The corrector 54 of the second embodiment can determine whether to perform color-difference correction (i.e., the second correction), on the basis of a predefined condition.

For instance, the corrector 54 can determine whether to perform the color-difference correction on the basis of the color-difference mean values (U mean value and V value) being an average of the color differences in the target region 78, and a preset color-difference mean threshold. The color-difference mean threshold is stored as numeric data 60 in the storage 52.

The corrector 54 can determine whether to perform the color-difference correction on the basis of a variation in the color differences in the target regions 78 and a preset variation threshold. The variation threshold is stored as numeric data 60 in the storage 52.

The corrector 54 can determine whether to perform the color-difference correction on the basis of a difference between the color-difference mean values of two or more target regions 78 (e.g., target regions 78FLa, 78FRa) of one image 70 and a preset difference threshold. The difference threshold is stored as numeric data 60 in the storage 52.

Alternatively, the corrector 54 may change the correction value under a predefined condition.

For example, the corrector 54 can determine whether to change a correction value set for correcting the color difference to a preset upper-limit correction value on the basis of the upper-limit correction value and the color-difference correction value. The upper-limit correction value represents the upper limit of the correction value and is stored as numeric data 60 in the storage 52.

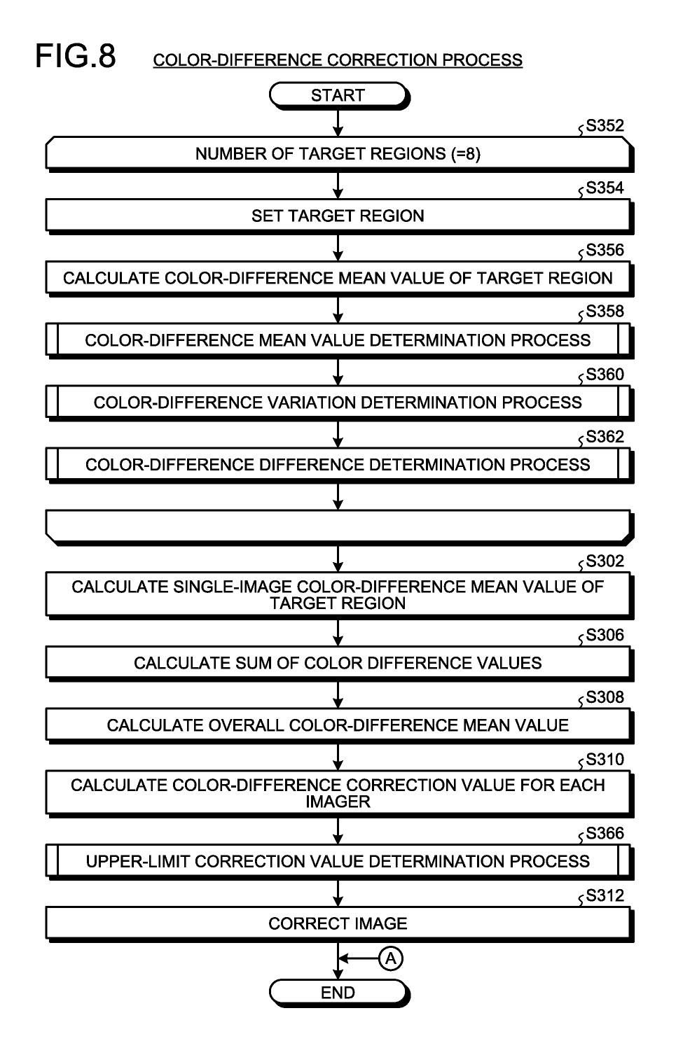

FIG. 8 is a flowchart of the color-difference correction process executed by the corrector 54 of the second embodiment. The same steps as in the first embodiment will be denoted by the same step numbers, and their description will be omitted.

In the color-difference correction process of the second embodiment, as illustrated in FIG. 8, the corrector 54 repeats the process from S354 to S362 by the number of the target regions 78 (eight in the present embodiment) (S352).

The corrector 54 sets one of the target regions 78 as a subject of determination on whether to correct (S354). The order of setting the target regions 78 is not particularly limited as long as the target region 78 set at even ordinal time and the target region 78 set at previous odd ordinal time are located in the same image 70. For example, the corrector 54 may first set the target region 78FLa and then the target regions 78FRa, 78FRd, . . . , 78FLc clockwise in order.

The corrector 54 calculates the color-difference mean values (U mean value and V mean value) of the set target region 78 (S356).

The corrector 54 executes color-difference mean value determination to determine whether to correct the color differences (S358).

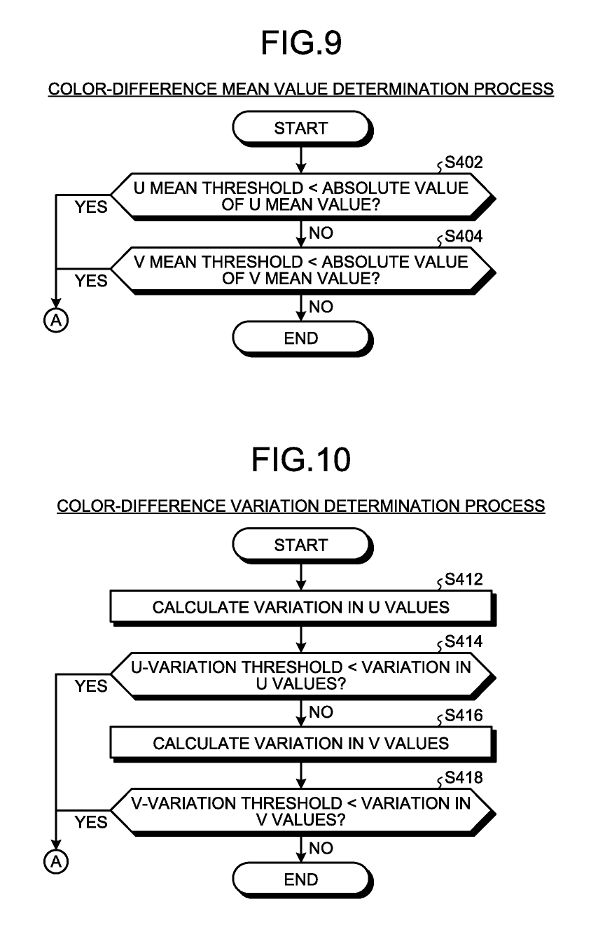

FIG. 9 is a flowchart of the color-difference mean value determination process executed by the corrector 54. Through the color-difference mean value determination process, the corrector 54 forbids setting the color-difference correction value when the images 70 do not contain grey color, that is, road surface.

As illustrated in FIG. 9, in the color-difference mean value determination process the corrector 54 determines whether the absolute value of the U mean value of the target region 78 exceeds a preset U mean threshold (S402). The U mean threshold is set to 50 when the U values are within ±128 gradations, for example.

Upon determining the absolute value of the U mean value of the target region 78 as being the U mean threshold or less (No in S402), the corrector 54 determines whether the absolute value of the V mean value of the target region 78 exceeds a preset V mean threshold (S404). The V mean threshold is set to 50 when the V values are within ±128 gradations, for example. Upon determining the absolute value of the V mean value of the target region 78 as being the V mean threshold or less (No in S404), the corrector 54 completes the color-difference mean value determination process and proceeds to step S360.

Meanwhile, upon determining the absolute value of the U mean value of the target region 78 as exceeding the U mean threshold (Yes in S402) or the absolute value of the V mean value of the target region 78 as exceeding the V mean threshold (Yes in S404), the corrector 54 completes the image generation process without correcting the color differences (refer to circled A in FIG. 8).

Returning to FIG. 8, the corrector 54 executes color-difference variation determination to determine whether to correct the color differences (S360).

FIG. 10 is a flowchart of the color-difference variation determination process executed by the corrector 54. The corrector 54 forbids setting the color-difference correction value through the color-difference variation determination process when the images 70 contain a white line or the like, to prevent false color arising from the correction value.

In the color-difference variation determination process, as illustrated in FIG. 10, the corrector 54 calculates a variation in the U values (S412). The variation represents a difference between the maximal U value and the minimal U value of the target region 78. The corrector 54 determines whether a variation in the U values exceeds a preset U-variation threshold (S414). The U-variation threshold is set to 20 when the U values are within 256 gradations, for example.

Upon determining the variation in the U values of the target region 78 as being the U-variation threshold or less (No in S414), the corrector 54 calculates a variation in the V values (S416). The variation represents a difference between the maximal V value and the minimal V value of the target region 78. The corrector 54 determines whether a variation in the V values exceeds a preset V-variation threshold (S418). The V-variation threshold is set to 20 when the V values are within 256 gradations, for example. Upon determining the variation in the V values of the target region 78 as being the V-variation threshold or less (No in S418), the corrector 54 completes the color-difference variation determination process and proceeds to step S362.

Meanwhile, upon determining the variation in the U values of the target region 78 as exceeding the U-variation threshold (Yes in S414) or the variation in the V values of the target region 78 as exceeding the V-variation threshold (Yes in S418), the corrector 54 completes the image generation process without correcting the color differences (refer to circled A in FIG. 8).

Returning to FIG. 8, the corrector 54 executes color-difference difference determination to determine whether to correct the color differences from a difference among the color differences in one of the images 70 (S362).

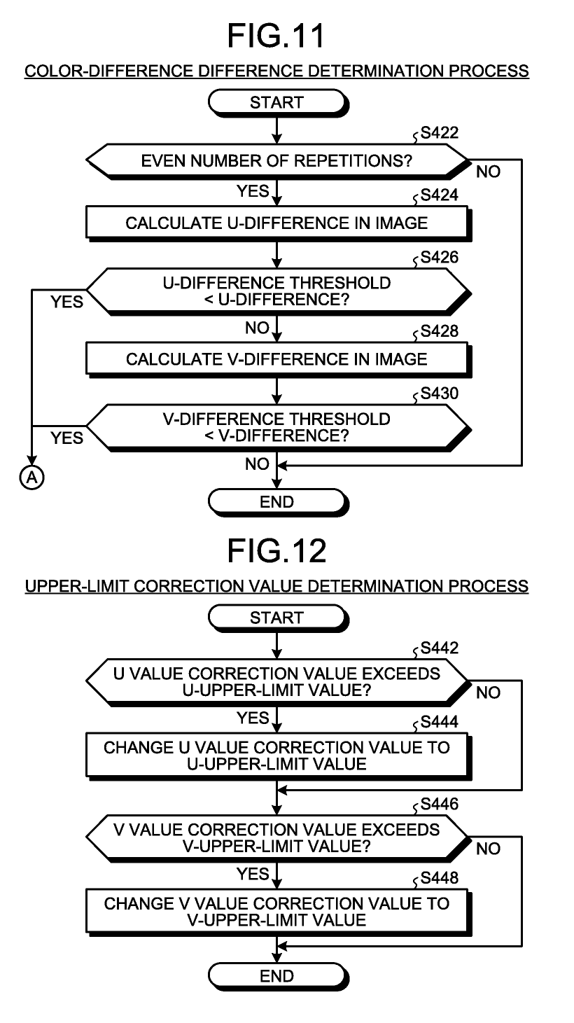

FIG. 11 is a flowchart of the color-difference difference determination process executed by the corrector 54. Through the color-difference difference determination process, the corrector 54 forbids setting the color-difference correction value when the one image 70 exhibits uneven color differences.

In the color-difference difference determination process, as illustrated in FIG. 11, the corrector 54 determines whether the number of repetitions of the process from the step S352 is an even number (S422). An even number of repetitions signify that the color-difference mean value of a different target region 78 in the image 70 by the same imager 14, for which the color-difference mean value has been calculated in step S356 of the current process, has been calculated. Upon determining that the number of repetitions is not an even number (No in S422), the corrector 54 completes the color-difference difference determination process and proceeds to step S352 or S302.

Upon determining that the number of repetitions is an even number (Yes in S422), the corrector 54 calculates a U-difference being a difference between the U mean values of two (e.g., target regions 78FLa, 78FRa) of the target regions 78 (S424). The corrector 54 determines whether the U-difference exceeds a preset U-difference threshold (S426). The U-difference threshold is set to 10 when the U values are within 256 gradations, for example.

Upon determining the U-difference as being the U-difference threshold or less (No in S426), the corrector 54 calculates a V-difference being a difference between the V mean values of two (e.g., target regions 78FLa, 78FRa) of the target regions 78 of the one image 70 (S428). The corrector 54 determines whether the V-difference exceeds a preset V-difference threshold (S430). The V-difference threshold is set to 10 when the V values are within 256 gradations, for example. Upon determining the V-difference as being the V-difference threshold or less (No in S430), the corrector 54 completes the color-difference difference determination process and proceeds to the step S352 or S302.

Meanwhile, upon determining the U-difference as exceeding the U-difference threshold (Yes in S426) or the V-difference as exceeding the V-difference threshold (Yes in S430), the corrector 54 completes the image generation process without correcting the color difference (refer to circled A in FIG. 8).

Returning to FIG. 8, after the repetitions of the process from step S352 by the number of the target regions 78, the corrector 54 executes the process from steps S302 to S310 as in the first embodiment to calculate the correction value for each color difference for each of the imagers 14.

Upon calculation of the correction values, the corrector 54 proceeds to an upper-limit correction value determination process to determine the upper-limit of the correction values (S366).

FIG. 12 is a flowchart of the upper-limit correction value determination process executed by the corrector 54. Through the upper-limit correction value determination process, the corrector 54 prevents degradation of the image quality of the peripheral image 72 due to a great color change caused by a large correction value.

In the upper-limit correction value determination process, as illustrated in FIG. 12, the corrector 54 determines whether the calculated correction value for the U values exceeds a preset upper-limit U value (S442). The upper-limit U value is set to 35 when the U values are within 256 gradations, for example. The corrector 54 changes the U value correction value to the upper-limit U value (S444) when the U value correction value exceeds the upper-limit U value (Yes in S442). When the U value correction value is the upper-limit U value or less (No in S442), the corrector 54 maintains the U value correction value with no change.

The corrector 54 determines whether the calculated correction value for the V values exceeds a preset upper-limit V value (S446). The upper-limit V value is set to 35 when the V values are within 256 gradations, for example. The corrector 54 changes the V value correction value to the upper-limit V value (S448) when the correction value exceeds the upper-limit V value (Yes in S446). When the V value correction value is the upper-limit V value or less (No in S446), the corrector 54 maintains the V value correction value with no change.

Thereby, the corrector 54 completes the upper-limit correction value determination process.

Returning to FIG. 8, the corrector 54 corrects the color differences among the images 70 on the basis of the calculated correction value or the upper-limit correction value (S312), completing the color-difference correction process.

As described above, in the second embodiment the corrector 54 forbids setting erroneous correction values through the color-difference mean value determination process, when the images 70 contain no road surface, for example. This prevents the peripheral image 72 from degrading in image quality by the correction.

Through the color-difference variation determination process, the corrector 54 forbids setting the color-difference correction value when the images 70 contain a white line, for example. This prevents false color which would otherwise arise from the correction value, and prevents the peripheral image 72 from degrading in image quality by the correction.

Through the color-difference difference determination process, the corrector 54 forbids setting erroneous correction values when one of the images 70 exhibits uneven color differences with a great variation. This prevents the peripheral image 72 from degrading in image quality due to erroneous correction values.

Through the upper-limit correction value determination process, the corrector 54 prevents the peripheral image 72 from degrading in image quality due to a great color change caused by a large correction value. The corrector 54 can set the correction value to a proper value (i.e., the upper-limit correction value) by the color-difference difference determination process when the correction value is too large.

The functions, connections, numbers, and arrangement of the elements of the first and second embodiments may be modified, added, or deleted when appropriate within the scope of the present invention or the scope of equivalency thereof. The embodiments may be combined when appropriate. The steps in the embodiments may be changed in order when appropriate.

The above embodiments have described the example of calculating the correction value in each image generation process, however, the example is for illustrative purposes only and not restrictive. Alternatively, the correction value may be calculated once in multiple image generation processes, or calculated only at the time of startup of the information processing unit 36, for instance.

The above embodiments have described the example of setting the target regions 78 of part of the overlapping regions 74 to the subject of the luminance and color-difference correction, however, the example is for illustrative purposes only and not restrictive. Alternatively, the target regions 78 may be enlarged to match the overlapping regions 74.

The second embodiment has described the example of executing all of the color-difference mean value determination process, the color-difference variation determination process, the color-difference difference determination process, and the upper-limit correction value determination process, however, the example is for illustrative purposes only and not restrictive. The image processing device 20 may execute one or two or more of the determination processes.

The above embodiments have described the vehicle 10 as an example of a mobile object, however, the mobile object is not limited thereto. The mobile object may be an airplane, a ship, or a bicycle, for instance.

The above embodiments have described the example in which the corrector 54 corrects the color differences on the basis of the difference between the overall color-difference mean value and the single-image color-difference mean value, however, the example is for illustrative purposes only and not restrictive. For example, the corrector 54 may correct the color differences among the images on the basis of a ratio of the single-image color-difference mean value to the overall color-difference mean value. In this case the corrector 54 may correct the color differences by dividing the color differences by the ratio.

The above embodiments have described the example in which the corrector 54 calculates the mean value of the color differences among all the target regions 78 as the overall color-difference mean value, however, the overall color-difference mean value is not limited thereto. For example, the corrector 54 may calculate the mean value of the color differences among all the images 70 as the overall color-difference mean value.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing device comprising:
a plurality of imagers disposed on an outer circumference of a mobile object, the imagers imaging surroundings of the mobile object to generate multiple images including mutually overlapping regions;
a processor that corrects luminance of the images through a first correction, and corrects color differences in the images through a second correction different from the first correction, to generate a peripheral image by combining the corrected images, wherein
in the first correction, the processor corrects, on the basis of a value regarding a luminance of a target region set in an overlapping region of a first one of the images, luminance of a target region set in a second one of the images; and
in the second correction, the processor corrects color difference in the first or second one of the images on the basis of a value regarding color-difference between the first one and the second one of the images.

2. The image processing device according to claim 1, wherein
in the second correction, the processor corrects the color difference in the image on the basis of an overall color-difference mean value and a single-image color-difference mean value, the overall color-difference mean value being an average of color differences among all of target regions or all the images, the single-image color-difference mean value being an average of color differences in the target region of the first one of the images.

3. The image processing device according to claim 1, wherein
the processor determines, on the basis of the color-difference mean value of the target regions and a preset color-difference mean threshold, whether to perform the second correction.

4. The image processing device according to claim 1, wherein
the processor determines, on the basis of a variation in the color differences in the target regions and a preset variation threshold, whether to perform the second correction.

5. The image processing device according to claim 1, wherein
the processor determines, on the basis of a difference in color-difference mean values of target regions of the first one of the images and a preset difference threshold, whether to perform the second correction.

6. The image processing device according to claim 1, wherein
the processor determines, on the basis of a correction value for correcting the color difference and a preset upper-limit correction value, whether to change the correction value to the upper-limit correction value.

7. The image processing device according to claim 6, wherein
the processor changes the correction value to the upper-limit correction value when the correction value set for correcting color-difference exceeds the upper-limit correction value.
